(19) United States
(12) Patent Application Publication
(10) Pub. No.: US 2020/0404452 A1
(43) Pub. Date: Dec. 24, 2020

(54) USER IDENTITY LOCATION TRACKING

(71) Applicant: Wells Fargo Bank, N.A., San Francisco, CA (US)

(72) Inventors: Sadananda Kalappanahally Nagarajappa, Bangalore (IN); Venu Andra, San Francisco, CA (US); Nathan Matthew Comstock, El Cerrito, CA (US); Balinder Singh Mangat, Castro Valley, CA (US); Chris Theodore Kalaboukis, San Jose, CA (US)

(21) Appl. No.: 15/672,853

(22) Filed: Aug. 9, 2017

(51) Int. Cl. H04W 4/02; H04W 64/00; H04L 29/08; G01S 5/02

(52) U.S. Cl. CPC H04W 4/028; G01S 5/0294; H04L 29/08657; H04W 64/003

(57) ABSTRACT

Systems and methods are disclosed for user identity location tracking. In one implementation, a first location instance associated with a user is received. The first location instance is encoded within a storage resource associated with the user. A request for a location of the user is received. The location of the user is determined based on the first location instance as stored within the storage resource. The determined location of the user is provided in response to the request.

### TECHNICAL FIELD

Aspects and implementations of the present disclosure relate to data processing, and more specifically, to user identity location tracking.

### BACKGROUND

Unique user accounts can be generated and issued to respective users. Such user accounts can be used to initiate or authorize various operation(s). The location of a user associated with such operations can be accounted for in determining whether to execute the operation(s).

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative system architecture, in accordance with one implementation of the present disclosure.

FIG. 2 depicts an exemplary implementation of a device in accordance with aspects and implementations of the present disclosure.

FIG. 3 depicts a flow diagram of aspects of a method for user identity location tracking in accordance with one implementation of the present disclosure.

FIG. 4 depicts a block diagram of an illustrative computer system operating in accordance with aspects and implementations of the present disclosure.

### DETAILED DESCRIPTION

Aspects and implementations of the present disclosure are directed to user identity location tracking.

It can be appreciated that the location of a user can be accounted for in numerous scenarios. For example, various types of transactions may request or attempt to determine the location of an associated user prior to completing/executing the transaction. Doing so can, for example, reflect the likelihood that the transaction is (or is not) likely to be legitimate/valid.

While various existing techniques are capable of determining a current location of a user, such techniques are still susceptible to fraud. Accordingly, even when identifying a current location of a user, it can still be difficult to assess whether a transaction being initiated is (or is not) likely to be legitimate.

Accordingly, described herein in various implementations are technologies, including methods, machine readable mediums, and systems, that enable user identity location tracking. For example, information corresponding to the current location of a user can be received from multiple sources (e.g., devices such as a smartphone, wearable device, implantable device, etc. associated with the user). A record of such information can be maintained, reflecting the location history of the user. While a single location instance (e.g., the location as received from a single device) may not conclusively reflect that the user is actually present at the current location, an increasing number of location instances (originating from difference devices) can increase such certainty. Accordingly, in a scenario in which multiple location instances reflect that the smartphone, wearable device, implantable device, etc., associated with the user are all located at a particular location at a particular time, it can be determined that the user him/herself was highly likely to actually have been present. Various transactions (and/or other operations) can be further executed/completed based on such determination, as described herein.

Accordingly, it can be appreciated that the described technologies are directed to and address specific technical challenges and longstanding deficiencies in multiple technical areas, including but not limited to location tracking, identity determination, and user authentication. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., (e.g., sensors, devices, etc.) referenced herein operate to enable, improve, and/or enhance the described technologies, such as in a manner described herein.

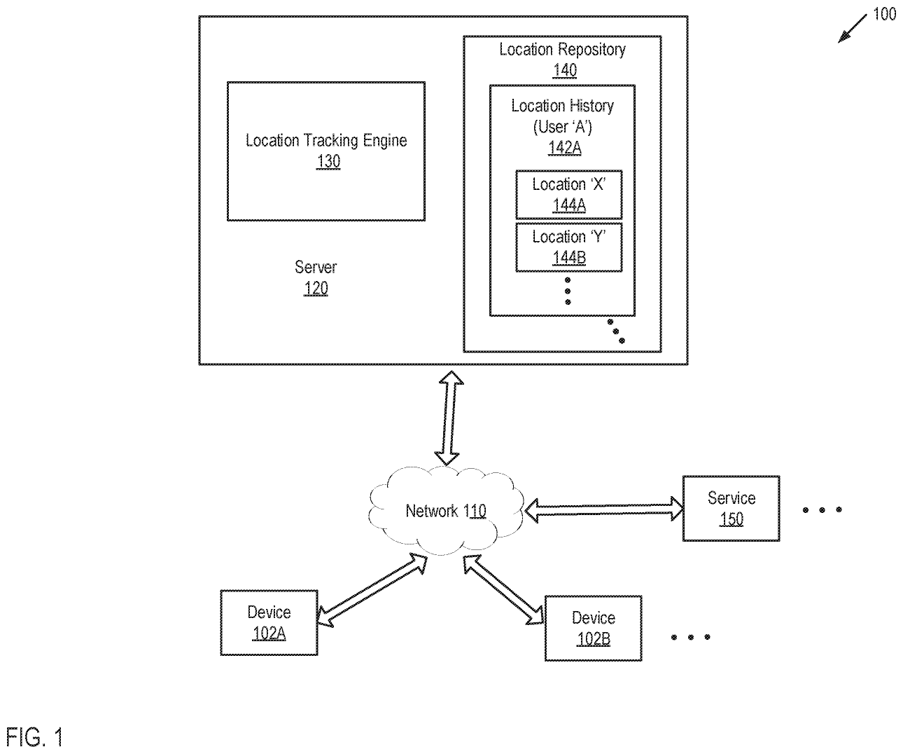

FIG. 1 depicts an illustrative system architecture 100, in accordance with one implementation of the present disclosure. The system architecture 100 includes one or more devices 102A-B, server 120, and service 150. These various elements or components can be connected to one another via network 110, which can be a public network (e.g., the Internet), a private network (e.g., a local area network (LAN) or wide area network (WAN)), or a combination thereof. Additionally, in certain implementations various elements can communicate and/or otherwise interface with one another.

Each device 102 can be a wearable device (e.g., a portable electronic device or component that includes one or more sensors, communication interfaces, etc., such as a fitness tracker), a mobile phone, a smartphone, a watch, a smartwatch, a rackmount server, a router computer, a personal computer, a portable digital assistant, a laptop computer, a tablet computer, a camera, a video camera, a netbook, a desktop computer, a media center, an in-vehicle computer/system, an implantable device, any combination of the above, or any other such device capable of implementing the various features described herein. Additionally, in certain implementations, such device(s) 102 can include cameras or other sensors that can observe the user (e.g., at a particular location). Such cameras/sensors can be stationary and/or be mounted to maneuverable devices (e.g., motorized vehicles, ‘drones,’ etc.), e.g., in order to capture information at various location(s).

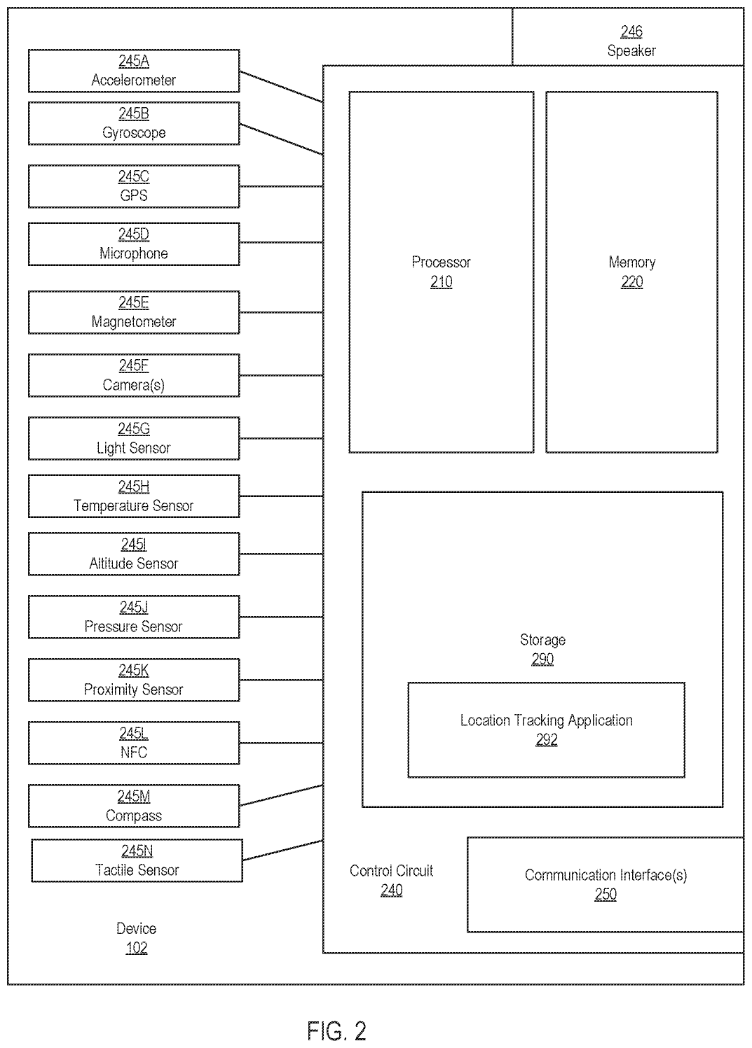

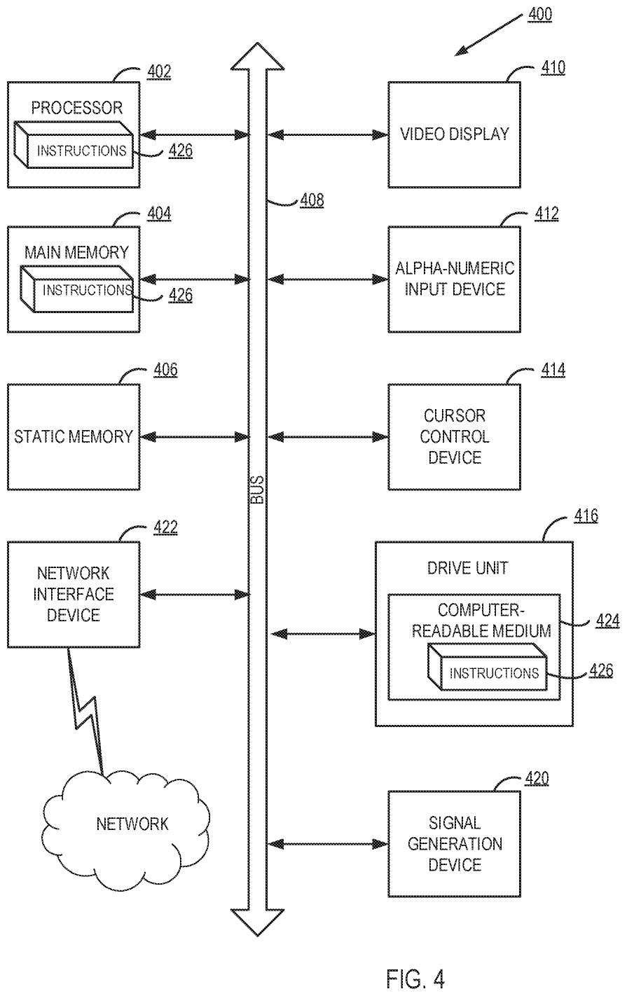

In certain implementations, various applications, such as mobile applications (‘apps’), web browsers, etc. can run on the device (e.g., on the operating system of the device). It should be understood that, in certain implementations, device 102 can also include and/or incorporate various sensors and/or communications interfaces (including but not limited to those depicted in FIGS. 2 and 4 and/or described/referenced herein). Examples of such sensors include but are not limited to: accelerometer, gyroscope, compass, GPS, haptic sensors (e.g., touchscreen, buttons, etc.), microphone, camera, etc. Examples of such communication interfaces include but are not limited to cellular (e.g., 3G, 4G, etc.) interface(s), Bluetooth interface, WiFi interface, USB interface, NFC interface, etc. As noted above, in certain implementations, device 102 can be an implantable device, such as is affixed, attached, inserted, etc. into the body of the user.

As noted, in certain implementations, device(s) 102 can also include and/or incorporate various sensors and/or communications interfaces. By way of illustration, FIG. 2 depicts one example implementation of device 102. As shown in FIG. 2, device 102 can include a control circuit 240 (e.g., a motherboard) which is operatively connected to various hardware and/or software components that serve to enable various operations, such as those described herein. Control circuit 240 can be operatively connected to processor 210 and memory 220. Processor 210 serves to execute instructions for software that can be loaded into memory 220. Processor 210 can be a number of processors, a multi-processor core, or some other type of processor, depending on the particular implementation. Further, processor 210 can be implemented using a number of heterogeneous processor systems in which a main processor is present with secondary processors on a single chip. As another illustrative example, processor 210 can be a symmetric multi-processor system containing multiple processors of the same type.

Memory 220 and/or storage 290 can be accessible by processor 210, thereby enabling processor 210 to receive and execute instructions stored on memory 220 and/or on storage 290. Memory 220 can be, for example, a random access memory (RAM) or any other suitable volatile or non-volatile computer readable storage medium. In addition, memory 220 can be fixed or removable. Storage 290 can take various forms, depending on the particular implementation. For example, storage 290 can contain one or more components or devices. For example, storage 290 can be a hard drive, a flash memory, a rewritable optical disk, a rewritable magnetic tape, or some combination of the above.

As shown in FIG. 2, storage 290 can store location tracking application 292. In certain implementations, location tracking application 292 can be, for example, instructions, an ‘app,’ etc., that can be loaded into memory 220 and/or executed by processing device 210. In doing so, location tracking application 292 can provide information regarding the current location of the user and/or the device, as described herein. For example, as described herein, location tracking application 292 can provide the current location of the device 102 and/or the user (e.g., geographic coordinates as determined via GPS 245C as described below) to server 120. In certain implementations, such location can be provided on a periodic/ongoing basis (e.g., every 10 minutes). In other implementations, such location can be provided in response to a request from server 120 (as described herein).

One or more communication interface(s) 250 are also operatively connected to control circuit 240. The various communication interface(s) 250 can include interfaces that enable communication between device 102 and one or more external devices, machines, services, systems, and/or elements (including but not limited to those depicted in FIG. 1 and described herein). Communication interface(s) 250 can include (but is not limited to) a modem, a Network Interface Card (NIC), an integrated network interface, a radio frequency transmitter/receiver (e.g., WiFi, Bluetooth, cellular, NFC), a satellite communication transmitter/receiver, an infrared port, a USB connection, or any other such interfaces for connecting device 102 to other computing devices, systems, services, and/or communication networks such as the Internet. Such connections can include a wired connection or a wireless connection (e.g. 802.11) or any other such interface that enables communication to/from the control circuit 240 and/or the various components described herein.

At various points during the operation of described technologies, device 102 can communicate with one or more other devices, systems, services, servers, etc., such as those depicted in FIG. 1 and/or described herein. Such devices, systems, services, servers, etc., can transmit and/or receive data to/from the device 102, thereby enhancing the operation of the described technologies. It should be understood that the referenced devices, systems, services, servers, etc., can be in direct/indirect communication with device 102, constant/ongoing communication with device 102, periodic communication with device 102, and/or can be communicatively coordinated with device 102, as described herein.

Also connected to and/or in communication with control circuit 240 of device 102 are one or more sensors 245A-245N (collectively, sensors 245). Sensors 245 can be various components, devices, and/or receivers that can be incorporated/integrated within and/or in communication with device 102. Sensors 245 can be configured to detect one or more stimuli, phenomena, or any other such inputs, described herein. Examples of such sensors 245 include, but are not limited to, an accelerometer 245A, a gyroscope 245B, a GPS receiver 245C, a microphone 245D, a magnetometer 245E, a camera 245F, a light sensor 245G, a temperature sensor 245H, an altitude sensor 245I, a pressure sensor 245J, a proximity sensor 245K, a near-field communication (NFC) device 245L, a compass 245M, and a tactile sensor 245N. As described herein, device 102 can perceive/receive various inputs from sensors 245 and such inputs can be used to initiate, enable, and/or enhance various operations and/or aspects thereof, such as is described herein.

While the foregoing description (e.g., with respect to sensors 245) has been directed to device(s) 102, various other devices, systems, servers, services, etc. (such as are depicted in FIG. 1 and/or described herein) can similarly incorporate the components, elements, and/or capabilities described with respect to device 102. For example, service 150 can also incorporate one or more of the referenced components, elements, and/or capabilities. It should also be understood that certain aspects and implementations of various devices, systems, servers, services, etc., such as those depicted in FIG. 1 and/or described herein, are also described in greater detail below in relation to FIG. 4.

Server 120 can be a rackmount server, a router computer, a personal computer, a portable digital assistant, a mobile phone, a laptop computer, a tablet computer, a camera, a video camera, a netbook, a desktop computer, a smartphone, a media center, a smartwatch, an in-vehicle computer/system, any combination of the above (e.g., multiple servers within a cloud service or framework), or any other such computing device capable of implementing the various features described herein. Server 120 can include components such as location tracking engine 130, and location repository 140. It should be understood that, in certain implementations, server 120 can also include and/or incorporate various sensors and/or communications interfaces (including but not limited to those depicted in FIG. 2 and described in relation to device 102). The components can be combined together or separated in further components, according to a particular implementation. It should be noted that in some implementations, various components of server 120 can run on separate machines (for example, location repository 140 can be a separate device). Moreover, some operations of certain of the components are described in more detail below.

Location repository 140 can be hosted by one or more storage devices or resources, such as main memory, magnetic or optical storage based disks, tapes or hard drives, NAS, SAN, and so forth. In some implementations, location repository 140 can be a network-attached file server, while in other implementations location repository 140 can be some other type of persistent storage such as an object-oriented database, a relational database, and so forth, that can be hosted by the server 120 or one or more different machines coupled to the server 120 via the network 110. In yet other implementations location repository 140 can be a database that is hosted by another entity and made accessible to server 120.

Location repository 140 can store information relating to locations (e.g., geographic coordinates, etc.) of various users. Such information can be stored in a location history associated with such a user. For example, as shown in FIG. 1, location history 142A is associated with user ‘A.’ Such location history 142A can include various locations, such as location ‘X’ 144A and location ‘Y’ 144B. Such locations reflect the geographic location at which user ‘A’ was determined to be present, e.g., at a particular time, over a period of time, etc. It should be understood that corresponding chronological information (e.g., a timestamp reflecting the time, date, etc., at which the user was present at such location) can also be stored with the geographic coordinates, etc., within location repository 140. In storing such locations, etc. in location history 142A, a record of the locations at which user ‘A’ is present can be maintained (e.g., over a period of days, weeks, months, etc.).

Additionally, as described herein, in certain implementations various device(s) 102 can include cameras or sensors (e.g. a security/surveillance camera) that perceive/observer the user (e.g., when the user is present in a particular location). Upon identifying the presence of the user within images/video captured by such a camera (e.g., using facial recognition techniques), the location of such a camera can be determined to be the location of the user, and such location can also be stored within a location history associated with the user.

It should be noted that the described technologies can include or incorporate various options to enable a user to ‘opt-in,’ ‘opt-out,’ and/or otherwise configure various settings with respect to the described functionality. For example, the user can configure what location information should or should not be stored. Additionally, the described technologies can utilize data encryption, identity verification, and/or related technologies to ensure that the referenced location(s)/location history cannot be accessed/retrieved by unauthorized parties. In doing so, the described technologies enable the described benefits and technical improvements to be realized while maintaining the security and privacy of the user's data.

Service(s) 150 can be, for example, third-party services that can provide various functionality, e.g., to the user and/or to device(s) 102. Examples of such services include but are not limited to transaction execution services (e.g., purchasing or delivery services), social networking services, etc.

It should be understood that though FIG. 1 depicts server 120, device(s) 102, and service 150 as being discrete components, in various implementations any number of such components (and/or elements/functions thereof) can be combined, such as within a single component/system.

As described in detail herein, various technologies are disclosed that enable user identity location tracking. In certain implementations, such technologies can encompass operations performed by and/or in conjunction with server 120, device(s) 102, and/or service(s) 150.

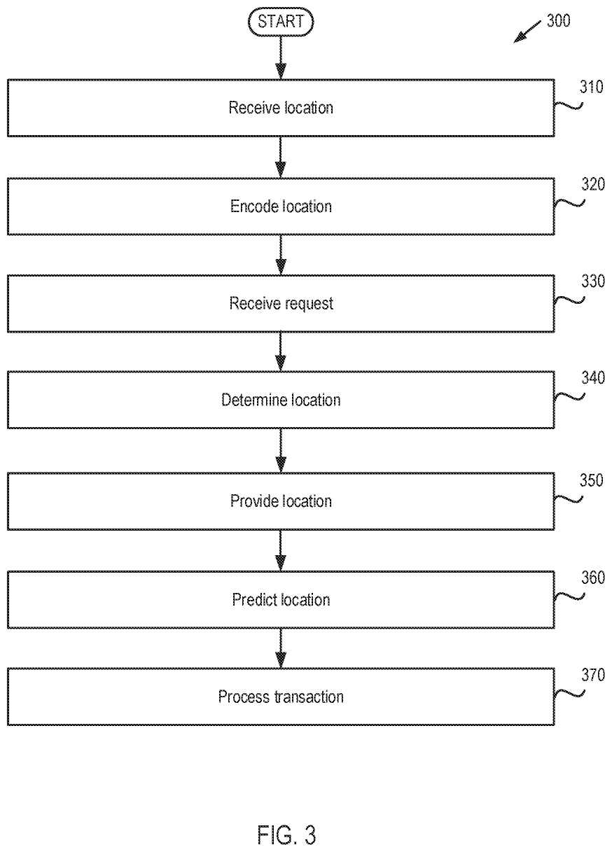

FIG. 3 depicts a flow diagram of aspects of a method 300 for user identity location tracking. The method is performed by processing logic that can comprise hardware (circuitry, dedicated logic, etc.), software (such as is run on a computing device such as those described herein), or a combination of both. In one implementation, the method is performed by one or more elements depicted and/or described in relation to FIG. 1 (including but not limited to server 120, location tracking engine 130, device(s) 102, and/or service(s) 150) and/or FIG. 2 (e.g., location tracking application 292 and/or device 102), while in some other implementations, one or more blocks of FIG. 3 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 310, a first location instance is received. Such a location instance can be associated with a user and can reflect, for example, the current location of the user (e.g., at a particular time). In certain implementations, such a location instance is received from a device associated with the user. By way of illustration, device 102 can be a smartphone, wearable device, embedded sensor, etc., associated with a user (e.g., an account, identifier, etc., associated with a human user). Location tracking application 292 executing on such a device can provide the current location (e.g., geographic coordinates) of the device. By way of further illustration, device 102 can be a camera or sensor that perceives the user, and the location of such camera/sensor can be provided as the location of the user. In certain implementations, various aspects of block 310 can be performed by server 120, location tracking engine 130 and/or location repository 140, while in other implementations such aspects can be performed by other elements/components, such as those described herein.

It should be noted that, in various implementations, information corresponding to the referenced location can be received from multiple sources. For example, a user may be associated with multiple devices (e.g., a smartphone, wearable device, implantable device, etc.), each of which can be capable of providing a location instance. Accordingly, in certain implementations, multiple location instances (each of which originates from a separate device associated with the user) can be provided (e.g., within the same chronological interval).

It can be appreciated that a single location instance may not necessarily reflect an absolute certainty that the user is actually present in the current location (for example, the user's smartphone may have been stolen or misplaced). In contrast, an increasing number of location instances (e.g., originating from multiple devices associated with the user) can further increase the likelihood that the user can be conclusively determined to be at a particular location. For example, in a scenario in which multiple location instances reflect that the smartphone, wearable device, implantable device, etc., associated with the user were all located at a particular location at a particular time, it can be determined that the user him/herself was highly likely to actually have been present.

At block 320, the first location instance (e.g., as received at 310) can be encoded or stored. In certain implementations, such location instance can be encoded within a storage resource, e.g., a storage resource associated with the user. Such a storage resource can be, for example, location repository 140 which includes location history 142A (as shown in FIG. 1 and described herein). As noted above, in certain implementations such a storage resource can include various other location(s)/location instance(s) associated with the user. For example, the location history associated with the user can include or reflect past location(s) at which the user has been determined to have been present. In certain implementations, various aspects of block 320 can be performed by server 120, location tracking engine 130 and/or location repository 140, while in other implementations such aspects can be performed by other elements/components, such as those described herein.

It should also be understood that, in certain implementations, the encoding the referenced location instance(s) can further utilize various storage technologies or techniques, including but not limited to distributed storage technologies (e.g., blockchain). Doing so can, for example, enhance the security, validity, and/or other aspects of the locations and other information stored therein.

At block 330, a request for a location of the user is received. In certain implementations, such a request can include or reflect a request for the location of the user (e.g., at a particular time, chronological interval, etc.). Such a request can originate from a service 150, such as a transaction execution service. For example, in conjunction with processing a transaction associated with a particular user (e.g., an ecommerce purchase, financial transaction, etc.) service 150 can request the location of the user. The location of the user can be used in determining, for example, the likelihood that such a transaction is (or is not) valid. In certain implementations, various aspects of block 330 can be performed by server 120, location tracking engine 130 and/or location repository 140, while in other implementations such aspects can be performed by other elements/components, such as those described herein.

At block 340, a location of the user can be determined. Such a location can reflect, for example, the current location of the user. In certain implementations, such a location can be determined based on the first location instance (e.g., as received at 310 and encoded at 320). In certain implementations, various aspects of block 340 can be performed by server 120, location tracking engine 130 and/or location repository 140, while in other implementations such aspects can be performed by other elements/components, such as those described herein.

For example, upon receiving a request for the location of the user (e.g., at 340), the location instance(s) received with respect to the user can be used to determine such a location. By way of illustration, the most recent location instance(s) received from the user can be used to determine a location (or range/radius of location) at which the user is presently likely to be. For example, in a scenario in which a location instance received with respect to a user was received 10 minutes ago, it can be determined that the user is likely not more than 10 miles away from the corresponding location.

By way of further illustration, the referenced request for the location of the user (e.g., as received at 340) can be received with respect to a previous chronological interval. For example, such a request can inquire regarding the location of the user at a particular time in the past (e.g., two weeks ago). In such a scenario, the location history of the user can be utilize to determine the location of the user at such a time.

At block 350, the location of the user can be provided. In certain implementations, such a location can be provided in response to the request (e.g., as received at 340). For example, information regarding the location of the user can be provided (e.g., transmitted/communicated to service 150) in response to the request. By way of further example, service 150 can be provided with access to location history 142 (e.g., via an application programming interface (API)) in response to the request. In certain implementations, various aspects of block 350 can be performed by server 120, location tracking engine 130 and/or location repository 140, while in other implementations such aspects can be performed by other elements/components, such as those described herein.

It should be understood that, in certain implementations, the described access to the location of the user may be controlled or limited, e.g., based on parameters or preferences defined by the user. For example, while location history 142 can maintain relatively precise location information associated with the user (which can, for example, be accurate within 50-100 meters), the user may not necessarily wish to share such specific information with certain (or any) service(s) 150. Accordingly, in certain implementations, certain aspects of the location of the user can be provided to such a service, while other aspects may not necessarily be provided.

By way of illustration, the user can configure the described technologies to share only certain aspects of their location information, e.g., relatively coarse/broad location information with certain service(s). For example, the user can elect to share coarse location information with requesting transaction execution service(s) (e.g., an ecommerce application requesting the location of a user in order to confirm a transaction). Such ‘coarse’ location information can reflect broad aspects of the location of the user (e.g., what city, state, etc., the user was located at a given time), without providing more specific location information to the service.

By way of further example, the user can user can elect to share fine location information with another service (e.g., a social networking application in which the user communicates with trusted friends/family). Such ‘fine’ location information can reflect specific aspects of the location of the user (e.g., the specific geographic location of the user at a given time). In doing so, the user can share specific/fine location information within services that the user trusts, while sharing general/coarse location information with other services (which may be sufficient, e.g., to identify a transaction as likely valid while not compromising the privacy of the user).

At block 360, a future location of the user can be predicted. For example, in certain implementations, the various locations of the user (as recorded over time) can be used to project subsequent locations of a user. For example, upon determining that a particular user is present at a particular location at regular intervals (e.g., visits another city every few months), it can be predicted that the user is likely to return to such a location again. In certain implementations, various aspects of block 360 can be performed by server 120, location tracking engine 130 and/or location repository 140, while in other implementations such aspects can be performed by other elements/components, such as those described herein.

At block 370, a transaction is processed. In certain implementations, such a transaction can be processed based on the location of the user. Such a location can include/reflect a current location if a user and/or a future/predicted location of the user. For example, in a scenario in which a transaction has been initiated with respect to the user, the current (or most recent) location of the user can be utilized to determine whether such a transaction is likely to be valid (and thus should be executed). In certain implementations, various aspects of block 370 can be performed by server 120, location tracking engine 130 and/or location repository 140, while in other implementations such aspects can be performed by other elements/components, such as those described herein.

By way of illustration, in a scenario in which a user initiates a purchase of a car in a particular location (e.g., in New York City), upon determining the user is currently (or most recently) located in California, it can be further determined that such a transaction may not be valid (and thus should not be approved/executed).

By way of further illustration, in a scenario in which a user is determined to periodically travel to certain locations (e.g., countries in South America), it can be further predicted that such user is likely to travel to such location(s) again. Accordingly, transactions originating from such location(s) can be determined to be likely (or more likely) to be valid. In contrast, it a scenario in which a subsequent transaction originates from another location (e.g., within Asia), the referenced prediction may not indicate that such a transaction is likely to be valid.

It should also be noted that while the technologies described herein are illustrated primarily with respect to user identity location tracking, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

FIG. 4 depicts an illustrative computer system within which a set of instructions, for causing the machine to perform any one or more of the methodologies discussed herein, can be executed. In alternative implementations, the machine can be connected (e.g., networked) to other machines in a LAN, an intranet, an extranet, or the Internet. The machine can operate in the capacity of a server in client-server network environment. The machine can be a computing device integrated within and/or in communication with a vehicle, a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing system (processor) 402, a main memory 404 (e.g., read-only memory (ROM), flash memory, dynamic random access memory (DRAM) such as synchronous DRAM (SDRAM)), a static memory 406 (e.g., flash memory, static random access memory (SRAM)), and a data storage device 416, which communicate with each other via a bus 408.

Processor 402 represents one or more processing devices such as a microprocessor, central processing unit, or the like. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 is configured to execute instructions 426 for performing the operations discussed herein.

The computer system 400 can further include a network interface device 422. The computer system 400 also can include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 420 (e.g., a speaker).

The data storage device 416 can include a computer-readable medium 424 on which is stored one or more sets of instructions 426 which can embody any one or more of the methodologies or functions described herein. Instructions 426 can also reside, completely or at least partially, within the main memory 404 and/or within the processor 402 during execution thereof by the computer system 400, the main memory 404 and the processor 402 also constituting computer-readable media. Instructions 426 can further be transmitted or received over a network via the network interface device 422.

While the computer-readable storage medium 424 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments can be practiced without these specific details. In some instances, structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “processing,” “providing,” “identifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein which can also include a computer program stored and/or executed by the apparatus. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It should be understood that the present disclosure is not described with reference to any particular programming language. It will be appreciated that a variety of programming languages can be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to practically any type of data. The scope of the disclosure should, therefore, be determined with reference to the appended claims, along with the full scope of equivalents to which such claims are entitled.

1. A method comprising:
receiving, from a first device, a first location instance reflecting a location of a user, the first device being worn by the user;
receiving, from a second device, a second location instance reflecting the location of the user, the second device perceiving the user;
encoding the first location instance and second location instance within a storage resource associated with the user, wherein the first location instance and the second location instance are stored in the storage resource with corresponding chronological information;
receiving a request for a current location of the user;
determining, by a processing device and based on the first location instance and the second location instance as stored within the storage resource, the current location of the user, wherein the current location is determined in part by predicting an approximate area of the location of the user based on the second location instance, wherein second chronological information for the second location instance indicates the second location instance occurred before the first location instance, and wherein an approximate location of the first location instance overlaps the approximate area;
identifying a service associated with the request, wherein the request corresponds to a transaction initiated via the service;
determining a location information level associated with the service for a user profile of the user;
determining that the current location of the user is valid for the service based on an evaluation of the location instances included in the storage resource;
upon determining that the current location of the user is valid, providing the determined current location of the user in accordance with the location information level associated with the service in response to the request; and
allowing execution of the transaction via the service based on the determined current location.

2. The method of claim 1, wherein the request comprises a request for the current location of the user at a chronological interval.

3.-4. (canceled)

5. The method of claim 1, wherein the location information level associated with the service limits access to an aspect of the current location of the user.

6. The method of claim 5, wherein the aspect is defined by the user.

7. The method of claim 1, wherein determining the current location of the user comprises determining a range of locations based on the first location instance and a time at which the first location instance was received.

8. The method of claim 1, further comprising predicting a future location of the user.

9. (canceled)

10. A system comprising:
processing device; and
a memory coupled to the processing device and storing instructions that, when executed by the processing device, cause the system to perform operations comprising:
receiving, from a first device, a first location instance reflecting a location of a user, the first device being worn by the user;
receiving, from a second device, a second location instance reflecting the location of the user, the second device perceiving the user;
encoding the first location instance and second location instance within a storage resource associated with the user, wherein the first location instance and the second location instance are stored in the storage resource with corresponding chronological information;
receiving a request for a current location of the user;
determining, based on the first location instance and the second location instance as stored within the storage resource, the current location of the user, wherein the current location is determined in part by predicting an approximate area of the location of the user based on the second location instance, wherein second chronological information for the second location instance indicates the second location instance occurred before the first location instance, and wherein an approximate location of the first location instance overlaps the approximate area;
identifying a service associated with the request, wherein the request corresponds to a transaction initiated via the service;
determining a location information level associated with the service for a user profile of the user;
determining that the current location of the user is valid for the service based on an evaluation of the location instances included in the storage resource;
upon determining that the current location of the user is valid, providing the determined current location of the user in accordance with the location information level associated with the service in response to the request; and
allowing execution of the transaction via the service based on the determined current location.

11. (canceled)

12. The system of claim 10, wherein the request comprises a request for the current location of the user at a chronological interval.

13.-14. (canceled)

15. The system of claim 10, wherein the location information level associated with the service limits access to an aspect of the current location of the user.

16. The system of claim 15, wherein the aspect is defined by the user.

17. The system of claim 10, wherein the memory further stores instructions for causing the system to perform operations comprising predicting a future location of the user.

18. (canceled)

19. A non-transitory computer readable medium having instructions stored thereon that, when executed by a processing device, cause the processing device to perform operations comprising:
receiving, from a first device, a first location instance reflecting a location of a user, the first device being worn by the user;
receiving, from a second device, a second location instance reflecting the location of the user, the second device perceiving the user;
encoding the first location instance and the second location instance within a storage resource associated with the user, wherein the first location instance and the second location instance are stored in the storage resource with corresponding chronological information;
receiving a request for a current location of the user;
determining, based on the first location instance and the second location instance as stored within the storage resource, the current location of the user, wherein the current location is determined in part by predicting an approximate area of the location of the user based on the second location instance, wherein second chronological information for the second location instance indicates the second location instance occurred before the first location instance, and wherein an approximate location of the first location instance overlaps the approximate area;
identifying a service associated with the request, wherein the request corresponds to a transaction initiated via the service;
determining a location information level associated with the service for a user profile of the user;
determining that the current location of the user is valid for the service based on an evaluation of the location instances included in the storage resource;
upon determining that the current location of the user is valid, providing the determined current location of the user in accordance with the location information level associated with the service in response to the request; and
allowing execution of the transaction via the service based on the determined current location.

20. (canceled)

21. The method of claim 1, further comprising:
determining that the current location of the user is invalid for the service based on an evaluation of the location instances included in the storage resource; and
preventing execution of the transaction via the service.

22. The system of claim 10, wherein the memory further stores instructions for causing the system to perform operations comprising:
determining that the current location of the user is invalid for the service based on an evaluation of the location instances included in the storage resource; and
preventing execution of the transaction via the service.
